(19) United States
(12) Patent Application Publication
(10) Pub. No.: US 2017/0090200 A1
(43) Pub. Date: Mar. 30, 2017

(54) DISPLAY DEVICE AND HEAD MOUNTED DISPLAY

(71) Applicant: Kabushiki Kaisha Toshiba, Tokyo (JP)

(72) Inventors: Hironori MOTOE, Ome Tokyo (JP); Shinji HIRATOMO, Ome Tokyo (JP); Shinichi KIDO, Hamura Tokyo (JP)

(21) Appl. No.: 15/058,989

(22) Filed: Mar. 2, 2016

Related U.S. Application Data
(60) Provisional application No. 62/235,084, filed on Sep. 30, 2015.

(51) Int. Cl. G02B 27/01

(52) U.S. Cl. CPC G02B 27/0176; G02B 27/0172; G02B 2027/0178; G02B 2027/0154; G02B 2027/0169

(57) ABSTRACT

According to an embodiment, a display device includes a first unit, a second unit, a flexible first connector, a flexible second connector, and a first limiter. The second unit is separated from the first unit and includes a display, an emitter, and an optical guide that emits light of an image from the emitter. The first connector electrically connects a substrate and the display with each other. The second connector connects the first unit and the second unit with each other in a mutually movable manner. The first limiter is provided in one of the first unit and the second unit and limits movement of the other of the first unit and the second unit in a first direction.

### CROSS-REFERENCE TO RELATED APPLICATIONS

This application is based upon and claims the benefit of priority from U.S. Provisional Application No. 62/235,084, filed on Sep. 30, 2015; the entire contents of which are incorporated herein by reference.

### FIELD

An embodiment described herein generally relates to a display device and a head mounted display.

### BACKGROUND

Some display devices are configured such that an image display element and the other elements of the device are mutually movably connected with each other.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of an HMD according to an embodiment;

FIG. 2 is an exemplary side view of the HMD in the embodiment;

FIG. 3 is an exemplary plan view of the HMD in the embodiment;

FIG. 4 is an exemplary plan view of a display device in the embodiment;

FIG. 5 is an exemplary perspective view of the display device in the embodiment;

FIG. 6 is an exemplary perspective view of the display device in the embodiment from a direction different from that of FIG. 5;

FIG. 7 is an exemplary rear view of the display device in the embodiment;

FIG. 8 is an exemplary plan view of the HMD with a temple opened in the embodiment; and

FIG. 9 is an exemplary side view of the HMD with the temple pivoted about a first rotational axis in the embodiment.

### DETAILED DESCRIPTION

In general, according to an embodiment, a display device includes a first unit, a second unit, a flexible first connector, a flexible second connector, and a first limiter. The first unit includes a substrate. The second unit is separated from the first unit and includes a display configured to display an image, an emitter configured to be exposed to an outside, and an optical guide configured to emit light of the image displayed on the display from the emitter. The first connector is configured to electrically connect the substrate and the display with each other. The second connector configured to connect the first unit and the second unit with each other in a mutually movable manner and hold the second unit with respect to the first unit. The first limiter is provided in one of the first unit and the second unit. The first limiter is configured to contact the other of the first unit and the second unit moved in a first direction to limit movement of the other of the first unit and the second unit in the first direction.

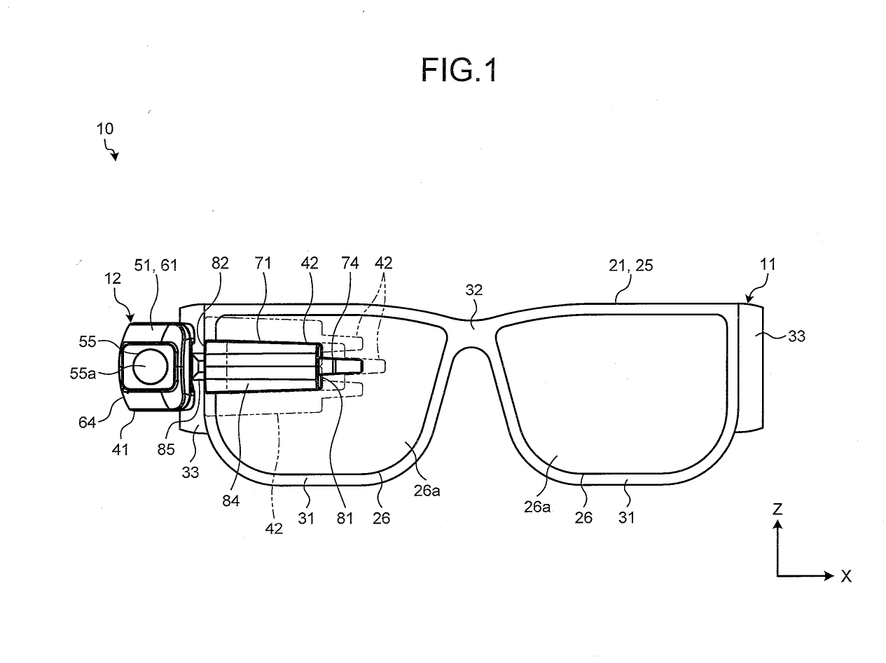

Hereinafter, one embodiment will be described with reference to FIG. 1 through FIG. 9. Elements according to the embodiment and descriptions thereof may be expressed differently. Any other different expressions and descriptions of the elements than the ones described herein are applicable. Furthermore, for the elements not given different expressions and descriptions herein, any other expressions are applicable.

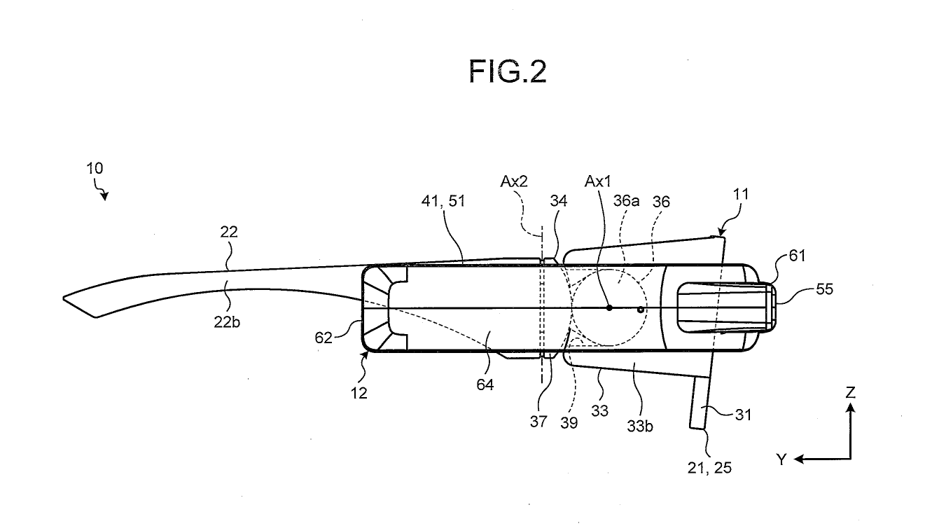

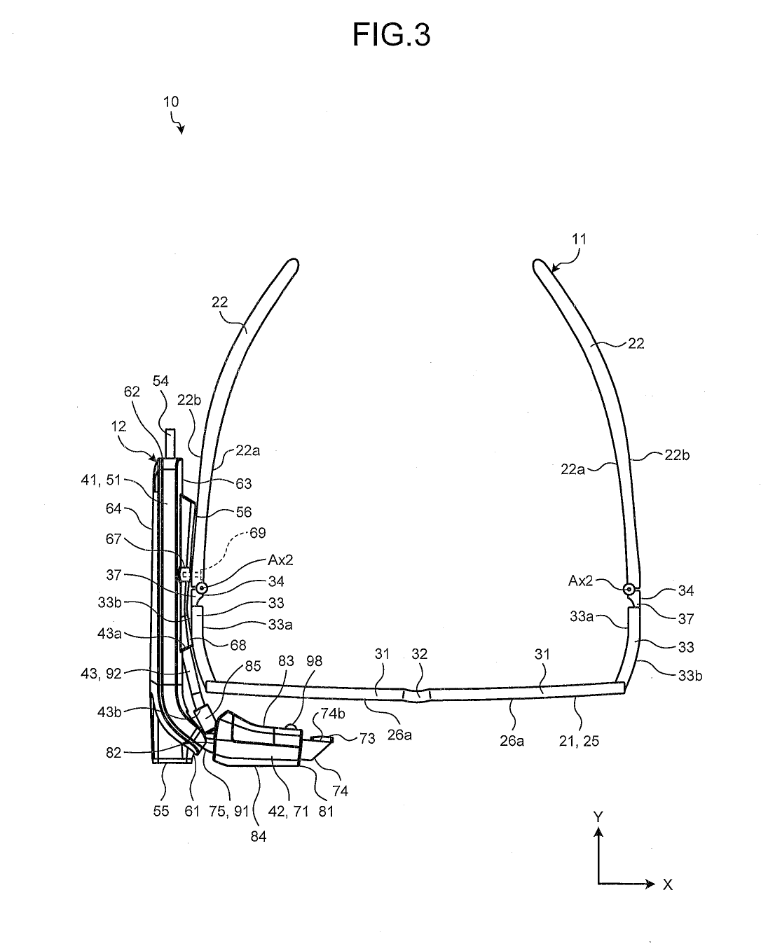

FIG. 1 is an exemplary front view of a head mounted display (HMD) 10 according to the embodiment. FIG. 2 is an exemplary side view of the HMD 10 of the embodiment. FIG. 3 is an exemplary plan view of the HMD 10 of the embodiment.

The HMD 10 includes eyeglasses 11 and a display device 12. The display device 12 is attached to the eyeglasses 11. Wearing the eyeglasses 11 with the display device 12 attached, a user can see images displayed on the HMD 10.

In the present specification, directions including frontward, rearward, leftward, rightward, upward, and downward are basically defined on the basis of a user's point of view when wearing the HMD 10. Frontward in the present specification refers to the direction in which the user wearing the HMD 10 is facing, for example.

The HMD 10 can also be called a wearable computer, a wearable device, smart glasses, a display device, or a device, for example. The eyeglasses 11 can also be called an ornament, a tool, or a wearable part, for example. The display device 12 can also be called an external device, an attached device, or a device, for example.

In the present specification, an X-axis, a Y-axis, and a Z-axis are defined as illustrated in the drawings. The X-axis, the Y-axis, and the Z-axis are orthogonal to each other. The X-axis extends along the width of the HMD 10. In other words, the X-axis extends leftward or rightward. The Y-axis extends along the length of the HMD 10. In other words, the Y-axis extends frontward or rearward. The Z-axis extends along the height of the HMD 10. In other words, the Z-axis extends upward or downward.

As illustrated in FIG. 3, the eyeglasses 11 include a front member 21 and two temples 22. The front member 21 is an example of a cover and can also be called a main part, for example. Each of the temples 22 can also be called an arm, a pivot portion, a support, or an attached part, for example.

As illustrated in FIG. 1, the front member 21 includes a frame 25 and two lenses 26. The frame 25 includes two rims 31, a bridge 32, and two end pieces 33.

The lenses 26 are mounted on the two respective rims 31. The two rims 31 are aligned along the X-axis. The bridge 32 connects the two rims 31 with each other. The two end pieces 33 are provided at both ends of the front member 21 in X-axis direction, respectively. In other words, the two rims 31 and the bridge 32 are positioned in-between the two end pieces 33. As illustrated in FIG. 3, the two end pieces 33 extend approximately rearward (Y-axis direction) from the corresponding rims 31.

Each of the two end pieces 33 includes an inside face 33a and an outside face 33b. The inside faces 33a of the two end pieces 33 face each other. In other words, the inside face 33a of one end piece 33 faces the inside face 33a of the other end piece 33. The inside faces 33a may be directed to other directions. The outside face 33b is on the opposite side of the inside face 33a.

As illustrated in FIG. 2, the front member 21 further includes two pivot members 34. The pivot members 34 can also be called hinges, for example. FIG. 2 illustrates only one of the two pivot members 34. Each of the pivot members 34 includes a first pivot portion 36 and a second pivot portion 37.

Recesses 39 are provided in the respective outside faces 33b of the two end pieces 33. The first pivot portions 36 of the two pivot members 34 are fit into the corresponding recesses 39 of the end pieces 33 to be attached to the end pieces 33.

Each of the pivot members 34 is attached to the end piece 33 pivotably about a first rotational axis Ax1 via the first pivot portion 36. The first rotational axis Ax1 is an example of a second axis.

The first rotational axis Ax1 is at a substantial center of the first pivot portion 36 in FIG. 2 and extends approximately in the X-axis direction. Each pivot member 34 is pivotable about the first rotational axis Ax1 clockwise and counterclockwise.

The pivot members 34 are pivotable within a certain angle range about the first rotational axis Ax1. When pivoting about the first rotational axis Ax1 by a certain angle, for example, the pivot members 34 contact edges of the end pieces 33 forming the recesses 39. However, the pivot members 34 may be pivotable by 360 degrees.

The first pivot portions 36 each include an outer face 36a. The outer face 36a is an example of a side face. The outer face 36a is directed in approximately the same direction as the outside face 33b of the end piece 33 to which the first pivot portion 36 is attached.

The second pivot portions 37 are connected to the first pivot portions 36. The second pivot portions 37 extend from the first pivot portions 36 substantially in the extending direction of the end pieces 33. In other words, the second pivot portions 37 extend approximately rearward (the Y-axis direction). The second pivot portions 37 may extend in a different direction.

The two temples 22 are attached to the corresponding second pivot portions 37 of the pivot members 34. Each of the temples 22 is connected to the front member 21 pivotably about a second rotational axis Ax2 via the second pivot portion 37. The second rotational axis Ax2 is an example of a first axis. In other words, each temple 22 is pivotable about the second rotational axis Ax2 with respect to the front member 21.

The second rotational axis Ax2 is positioned at a rear end of the second pivot portion 37 and a front end of the temple 22. When each pivot member 34 extends approximately in the Y-axis direction, the second rotational axis Ax2 is approximately along the Z-axis. The first rotational axis Ax1 and the second rotational axis Ax2 are extended in directions orthogonal to each other. The direction of the second rotational axis Ax2 is extended changes by the pivoting of the pivot member 34 about the first rotational axis Ax1.

Each temple 22 is pivotable about the second rotational axis Ax2 clockwise and counterclockwise. The temple 22 is pivotable about the second rotational axis Ax2 within a certain angle range.

Each temple 22 is pivotable about the first rotational axis Ax1 together with the pivot member 34 with respect to the front member 21. In other words, the temple 22 pivots about the first rotational axis Ax1 and is moveable upward or downward. The pivot member 34 supports the temple 22 pivotably about the first rotational axis Ax1 and the second rotational axis Ax2 with respect to the front member 21, for example.

As illustrated in FIG. 3, each of the two temples 22 includes an inside face 22a and an outside face 22b. When the two temples 22 extends approximately along the Y-axis, the inside faces 22a of the two temples 22 oppose each other. In other words, the inside face 22a of one temple 22 opposes the inside face 22a of the other temple 22. The inside faces 22a may be directed in other directions. The outside face 22b is on the opposite side of the inside face 22a.

The inside face 33a and the outside face 33b of each end piece 33 are directed to the circumference of the second rotational axis Ax2. The outer face 36a of the first pivot portion 36 of each pivot member 34 is also directed to the circumference of the second rotational axis Ax2.

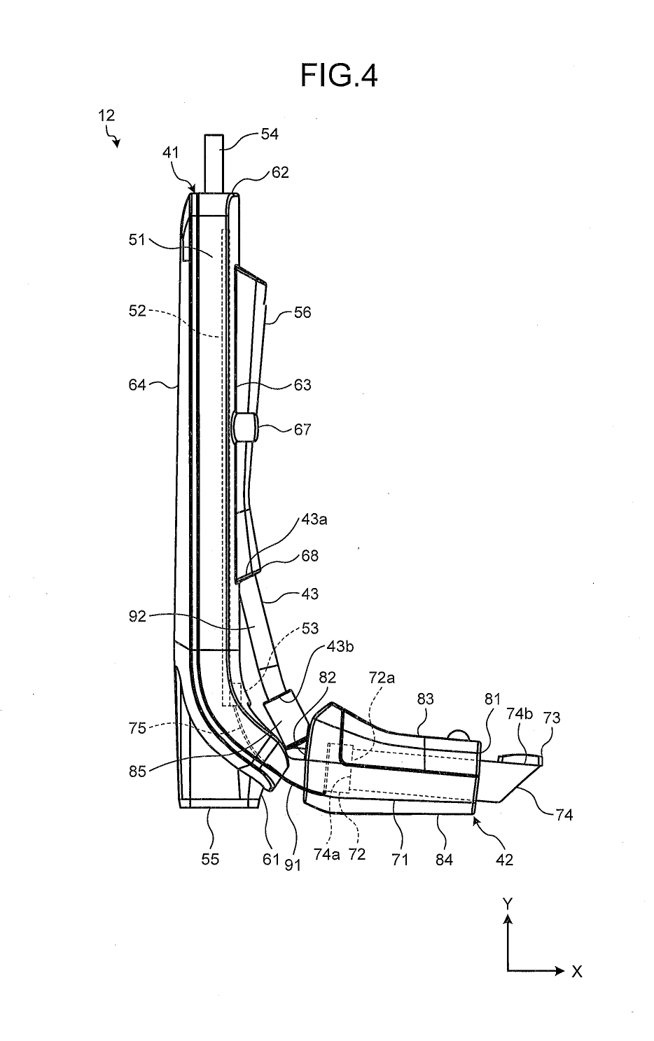

FIG. 4 is an exemplary plan view of the display device 12 in the embodiment. As illustrated in FIG. 4, the display device 12 includes a body 41, an optical element 42, and a flexible arm 43. The body 41 is an example of the first unit. The optical element 42 is an example of the second unit. The flexible arm 43 is an example of the second connector and can also be called a support, a deforming portion, or a flexible portion.

The body 41 includes a first casing 51, a substrate 52, a connector 53, a cable 54, a camera 55, and a speaker 56. The body 41 may further include other elements such as a microphone, an acceleration sensor, a gyro sensor, and a temperature sensor.

The first casing 51 is made of a synthetic resin, for example. The first casing 51 may be made of a different material such as a metal. As illustrated in FIG. 3, the first casing 51 is attached to the outside face 22b of one of the temples 22. The first casing 51 may be attached to a different place.

As illustrated in FIG. 4, the first casing 51 houses the substrate 52, the connector 53, a part of the cable 54, at least a part of the camera 55, and at least a part of the speaker 56. The first casing 51 includes a front end 61, a rear end 62, an inner portion 63, and an outer portion 64.

The front end 61 is one end of the first casing 51 in the extending direction (along the Y-axis, for example) of the temple 22. The rear end 62 is the other end of the first casing 51 in the extending direction of the temple 22. The rear end 62 is on the opposite side of the front end 61. The front end 61 is closer to the front member 21, for example, than the rear end 62.

The inner portion 63 opposes the outside face 22b of the temple 22 to which the first casing 51 is attached. In other words, the inner portion 63 is an end of the first casing 51 in a direction in which the first casing 51 faces the temple 22. The outer portion 64 is on the opposite side of the inner portion 63.

Two bosses 67 and a lateral stopper 68 are provided on the inner portion 63. Each of the bosses 67 is an example of an affixing portion. The lateral stopper 68 is an example of a second limiter and can also be called a protrusion, for example. FIG. 4 illustrates only one of the two bosses 67.

The two bosses 67 protrude toward the outside face 22b of the temple 22. The bosses 67 are secured on the temple 22 by screws 69 indicated by the broken line in FIG. 3. The bosses 67 may be secured on the temple 22 by another means such as a double-sided tape.

As described above, the display device 12 is attached not to the front member 21 but to the temple 22. This can prevent a decrease in the strength of the front member 21.

The lateral stopper 68 is placed closer to the front end 61 than the bosses 67. In other words, when the temple 22 extends along the Y-axis approximately, the lateral stopper 68 comes closer to the front member 21 than the bosses 67.

The position of the lateral stopper 68 corresponds to that of the first pivot portion 36 of the pivot member 34. The lateral stopper 68 protrudes toward the first pivot portion 36. In other words, the lateral stopper 68 protrudes toward the front member 21 of the eyeglasses 11.

When the temple 22 extends along the Y-axis approximately, the lateral stopper 68 abuts on the outer face 36a of the first pivot portion 36 of the pivot member 34. Along with the pivot of the temple 22 about the second rotational axis Ax2, the lateral stopper 68 may be separated from the first pivot portion 36.

The substrate 52 indicated by the broken line in FIG. 4 is a printed circuit board (PCB), for example. The substrate 52 may be a different substrate such as a flexible printed circuit board (FPC). A CPU that controls the display device 12, a memory that stores therein information, and other electronic components are mounted on the substrate 52, for example. The connector 53 is further mounted on the substrate 52.

The cable 54 is connected to the substrate 52. The cable 54 extends from the rear end 62 of the first casing 51 to the outside of the first casing 51, for example. The cable 54 is a USB cable, for example. The cable 54 may be a different cable such as an HDMI cable. The cable 54 connects the substrate 52 and an external apparatus such as a personal computer with each other, for example.

As illustrated in FIG. 1, the camera 55 includes a shooting lens 55a. The shooting lens 55a is provided at the front end 61 of the first casing 51. The camera 55 captures an image of a front area of the HMD 10 through the shooting lens 55a.

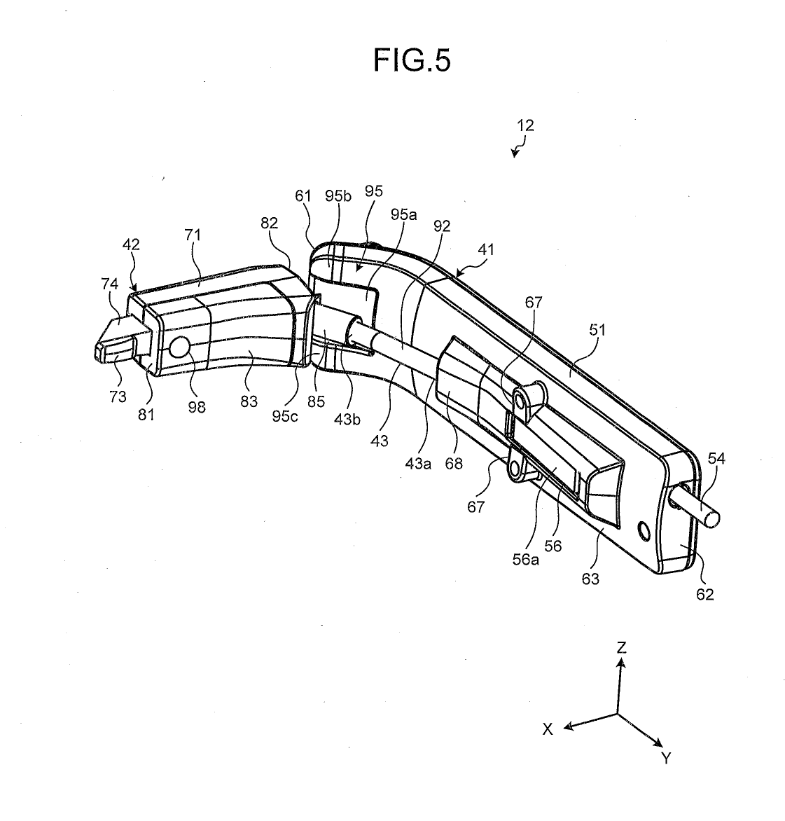

FIG. 5 is an exemplary perspective view of the display device 12 in the embodiment. The speaker 56 illustrated in FIG. 5 is a bone conduction speaker. The speaker 56 may be a different speaker.

The speaker 56 includes a vibrator 56a. The vibrator 56a is provided on the inner portion 63 of the first casing 51. The vibrator 56a is in contact with the outside face 22b of the temple 22 t which the first casing 51 is attached.

The speaker 56 vibrates the temple 22 with the vibrator 56a. The speaker 56 conveys vibrations as sound to the skull of the user wearing the HMD 10 via the temple 22, for example. In other words, the user can hear the sound issued from the speaker 56 via the temple 22.

As illustrated in FIG. 4, the optical element 42 is an independent element from the body 41. In other words, the optical element 42 can be separated from the body 41. The optical element 42 is movable with respect to the body 41. The optical element 42 may contact the body 41.

The optical element 42 includes a second casing 71, a display 72, a display lens 73, a prism 74, and a flexible circuit board (FPC) 75. The display lens 73 is an example of the emitter. The prism 74 is an example of the optical guide. The FPC 75 is an example of the first connector and a flexible substrate.

The second casing 71 is made of a synthetic resin. The second casing 71 may be made of a different material such as a metal. The second casing 71 is movably attached to the body 41 via the flexible arm 43 with respect to the body 41.

The second casing 71 extends along the X-axis approximately, for example. In other words, the second casing 71 extends in a direction crossing the extending direction of the body 41. That is, the second casing 71 extends along the lens 26. The extending direction of the second casing 71 can be changed.

The second casing 71 houses the display 72, at least a part of the prism 74, and a part of the FPC 75. The second casing 71 includes a distal end 81, a basal end 82, an inner portion 83, an outer portion 84, and a junction 85. The junction 85 can also be called a protrusion, for example.

The distal end 81 is one end of the second casing 71 in the extending direction (along the X-axis, for example) of the second casing 71. The basal end 82 is the other end of the second casing 71 in the extending direction. The basal end 82 is on the opposite side of the distal end 81. The basal end 82 is closer to the body 41 than the distal end 81.

As illustrated in FIG. 3, the inner portion 83 opposes a surface 26a of the corresponding lens 26. In other words, the inner portion 83 is an end of the second casing 71 in a direction in which the second casing 71 faces the lens 26. The outer portion 84 is on the opposite side of the inner portion 83.

The junction 85 protrudes from the basal end 82. The junction 85 substantially protrudes toward the lateral stopper 68 of the body 41, for example. The junction 85 may protrude in a different direction. The length of the junction 85 along the Z-axis is shorter than the maximal length of the second casing 71 along the Z-axis.

The display 72 indicated by the broken line in FIG. 4 is an organic light emitting display (OLED), for example. The display 72 may be a different display such as a liquid crystal display (LCD). The display 72 includes a screen 72a. The display 72 displays images on the screen 72a.

The display lens 73 is positioned outside the second casing 71 and exposed to the outside of the second casing 71. The display lens 73 may be provided in the second casing 71. The display lens 73 faces the surface 26a of the lens 26. In other words, the surface 26a of the lens 26 opposes the display lens 73.

The prism 74 includes a first end 74a and a second end 74b. The prism 74 reflects incident light from one of the first end 74a and the second end 74b by the inside and emits the light from the other of the first end 74a and the second end 74b.

A part of the prism 74 including the first end 74a is housed in the second casing 71. A part of the prism 74 including the second end 74b protrudes from the distal end 81 of the second casing 71 to be exposed to the outside of the second casing 71.

The first end 74a of the prism 74 faces the screen 72a of the display 72. The display lens 73 is provided at the second end 74b of the prism 74. The display lens 73 may be attached to the second end 74b or formed integrally with the prism 74, for example.

The prism 74 reflects light from a displayed image on the screen 72a of the display 72 by the inside and emits the light from the display lens 73. The light of the displayed image displayed on the screen 72a of the display component 72 is emitted from the screen 72a and incident on the eye of the user. The user can recognize the incident light as an image.

The FPC 75 is connected to the display 72 and extends from the display 72. The display 72 is mounted on an end of the FPC 75, for example. The FPC 75 may be formed integrally with the display 72. The FPC 75 extends from the basal end 82 of the second casing 71 toward the outside.

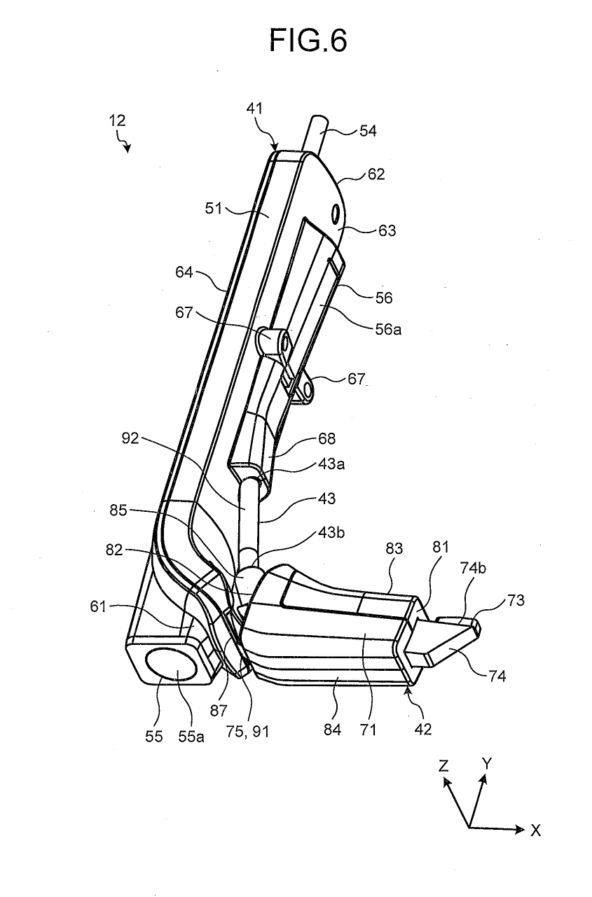

FIG. 6 is an exemplary perspective view of the display device 12 in the embodiment from a direction different from that of FIG. 5. As illustrated in FIG. 6, a slit 87 is provided in the front end 61 of the first casing 51 of the body 41. The slit 87 is an example of an opening.

The slit 87 extends in the Z-axis direction. The Z-axis direction is an example of the first direction. The length of the slit 87 along the Z-axis is longer than the length (width) of the FPC 75 along the Z-axis.

Extending from the basal end 82 of the second casing 71 of the optical element 42, the FPC 75 inserts through the slit 87. As illustrated in FIG. 4, a part of the FPC 75 is housed in the first casing 51 of the body 41. The part of the FPC 75 is connected to the connector 53 inside the first casing 51. The FPC 75 electrically connects the substrate 52 and the display 72 with each other.

Along with the motion of the optical element 42 in the Z-axis direction with respect to the body 41, for example, the FPC 75 can move in the Z-axis direction inside the slit 87. Along with the motion of the optical element 42 in the X-axis direction with respect to the body 41, for example, the FPC 75 can move in the X-axis direction through the slit 87. In other words, the FPC 75 is partially pulled out of the body 41 or inserted into the body 41 through the slit 87.

The FPC 75 has flexibility. The FPC 75 can be partially bent inside the first casing 51 of the body 41, for example. In other words, the first casing 51 contains a space in which a part of the FPC 75 can be accommodated and bent.

The flexible arm 43 movably connects the body 41 and the optical element 42 with each other at a distant position from the FPC 75. The FPC 75 is provided at a position farther from the front member 21 than the flexible arm 43. In the present embodiment, the flexible arm 43 is hollow.

The flexible arm 43 includes a first end 43a and a second end 43b. The first end 43a is connected to the lateral stopper 68 of the body 41. In other words, the flexible arm 43 is connected to the body 41 at a position nearer to the lateral stopper 68 than the bosses 67. The second end 43b is connected to the junction 85 of the optical element 42.

The FPC 75 includes a first exposed portion 91. The first exposed portion 91 is a portion of the FPC 75. The first exposed portion 91 is exposed to the outside and extends between the body 41 and the optical element 42. The first exposed portion 91 is insulated from the outside through a film, for example.

The flexible arm 43 includes a second exposed portion 92. The second exposed portion 92 is a portion of the flexible arm 43. The second exposed portion 92 is exposed to the outside and extends between the lateral stopper 68 of the body 41 and the junction 85 of the optical element 42.

The length of the first exposed portion 91 is shorter than the length of the second exposed portion 92. In the present embodiment, the length of the first exposed portion 91 is the length along the center of a cross section thereof. The length of the second exposed portion 92 is the length along the center of a cross section thereof.

The length of the first exposed portion 91 changes by the movement of the optical element 42 with respect to the body 41. However, the maximal length of the first exposed portion 91 is also shorter than the length of the second exposed portion 92. The maximal length of the first exposed portion 91 may be longer than the length of the second exposed portion 92.

The flexible arm 43 holds the optical element 42 with respect to the body 41. Specifically, the flexible arm 43 maintains the position of the optical element 42 with respect to the body 41 at least for a certain period of time to prevent a change in the position of the optical element 42 due to the weights of the optical element 42 and the flexible arm 43. The flexible arm 43 is deformed when applied with an external force, which can change the position of the optical element 42 with respect to the body 41.

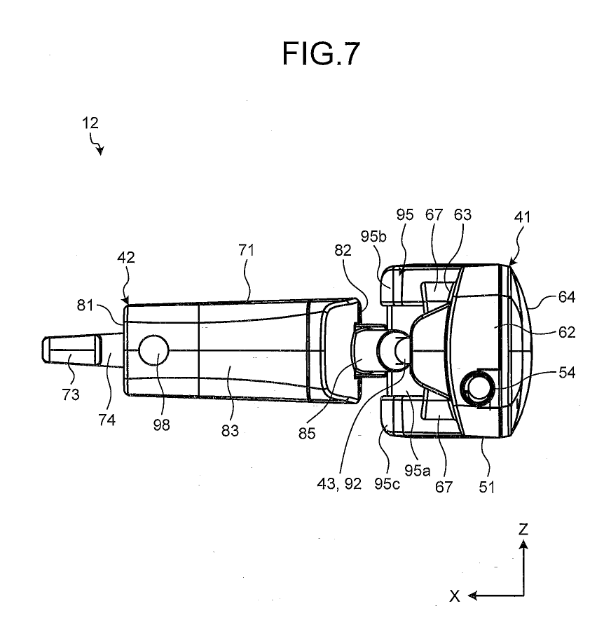

FIG. 7 is an exemplary rear view of the display device 12 in the embodiment. As illustrated in FIG. 7, a vertical stopper 95 is provided in the body 41. The vertical stopper 95 is an example of the first limiter. The vertical stopper 95 may be provided in the optical element 42. The vertical stopper 95 includes a basal plane 95a, a first protrusion 95b, and a second protrusion 95c.

The basal plane 95a is provided on the connecting portion of the front end 61 and the inner portion 63 in the first casing 51 of the main body 41. The basal plane 95a may be provided in a different position. Although the basal plane 95a in the present embodiment has a flat surface, it may be a concaved surface, for example.

The first protrusion 95b protrudes from the basal plane 95a at one end of the first casing 51 in the Z-axis direction. The second protrusion 95c protrudes from the basal plane 95a at the other end of the first casing 51 in the Z-axis direction. In other words, the second protrusion 95c is separated from the first protrusion 95b in the Z-axis direction.

That is, the vertical stopper 95 is a recess in the connecting portion of the front end 61 and the inner portion 63 in the first casing 51 of the main body 41. One edge of the recess is separated from the other edge in the Z-axis direction.

At least a part of the junction 85 of the optical element 42 is positioned in-between the first protrusion 95b and the second protrusion 95c in the Z-axis direction. By the movement of the optical element 42 with respect to the body 41, the junction 85 may be exposed to the outside between the first protrusion 95b and the second protrusion 95c. Another part of the optical element 42 may be positioned in-between the first protrusion 95b and the second protrusion 95c.

Furthermore, a contact stopper 98 is provided on the optical element 42. The contact stopper 98 is an example of a third limiter. The contact stopper 98 protrudes from the inner portion 83 of the second casing 71 of the optical element 42 toward the surface 26a of the lens 26.

The contact stopper 98 is made of a synthetic rubber, for example. The contact stopper 98 may be made of a different material having a lower modulus of longitudinal elasticity than that of the material of the display lens 73. The contact stopper 98 has a substantially semispherical shape. The contact stopper 98 may have a different shape. The contact stopper 98 is closer to the surface 26a of the lens 26 than the display lens 73.

Information is input to the CPU on the substrate 52 from an apparatus such as an external personal computer via the cable 54, for example. The CPU controls the display 72 via the FPC 75 to display an image based on the input information.

The light from the displayed image on the display 72 is reflected by inside the prism 74, emitted from the display lens 73, and incident on the eye of the user. Thereby, the user can see the displayed image on the display 72 via the prism 74.

The user can wear the HMD 10 as eyeglasses. The positions of the eyes vary among individuals. Therefore, the position of the display lens 73 may be deviated from a user's line of sight. The user can place the lens 73 in front of one of his or her eyes by moving the optical element 42 with respect to the body 41.

The user pinches the optical element 42 with the fingers to move the optical element 42 with respect to the body 41, for example. The flexible arm 43 and the FPC 75 are deformed to be able to change the position of the optical element 42 with respect to the body 41. The flexible arm 43 holds the optical element 42 at the moved position with respect to the body 41.

As indicated by the chain double-dashed line in FIG. 1, the user can move the optical element 42 in the Z-axis direction. When the optical part 42 is moved in the Z-axis direction with respect to the body 41 the junction 85 of the optical element 42 contacts with the first protrusion 95b or the second protrusion 95c. With this operation, the vertical stopper 95 limits further movement of the optical element 42 in the Z-axis direction. In the present embodiment, the vertical stopper 95 limits the movement of the optical element 42 in the Z-axis direction along the surface 26a of the lens 26. Furthermore, as illustrated by the chain double-dashed line in FIG. 1, the user can also move the optical element 42 in the X-axis direction.

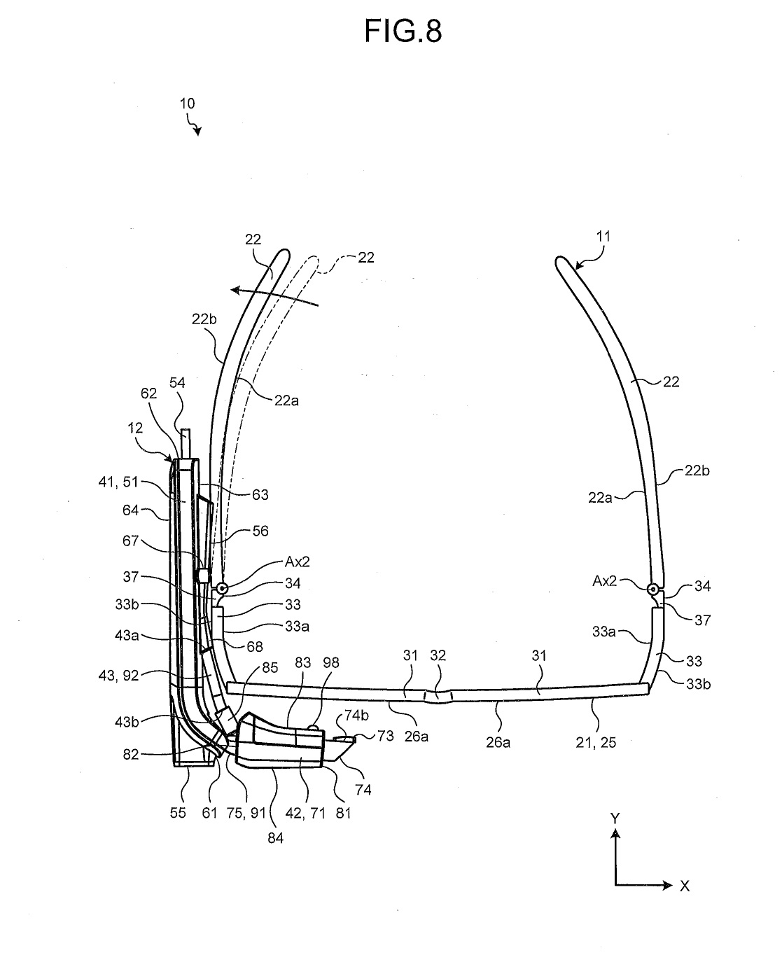

FIG. 8 is an exemplary plan view of the HMD 10 with the temple 22 opened according to the embodiment. As illustrated in FIG. 8, the temples 22 can be opened. In other words, one of the temples 22 to which the display device 12 is attached may be pivoted about the second rotational axis Ax2 so as to be distant away from the other temple 22. In FIG. 8 the opened temple 22 is represented by the solid line and the unopened temple 22 is represented by the chain double-dashed line.

Together with the opening of the temple 22, the display device 12 attached to the temple 22 is going to pivot about the second rotational axis Ax2. The optical element 42 is also going to pivot about the second rotational axis Ax2 and approach the surface 26a of the lens 26.

The lateral stopper 68 works to contact not the opened temple 22 but the outer face 36a of the first pivot portion 36 of the front member 21. Because of this, the display device 12 is prevented from pivoting about the second rotational axis Ax2, which leads to roughly maintaining the distance between the optical element 42 and the surface 26a of the lens 26.

When the optical element 42 approaches the lens 26, the contact stopper 98 may contact the surface 26a of the lens 26. The contact stopper 98 works to prevent the display lens 73 from contacting the surface 26a of the lens 26. Furthermore, the contact stopper 98 works to prevent the display lens 73 from contacting the surface 26a of the lens 26 when the user moves the optical element 42 in the Y-axis direction.

As described above, the user can move the optical element 42 with respect to the body 41 in the X-axis, Y-axis and Z-axis directions. The user can move the display lens 73 to the front of his or her eye to view the image on the screen 72a of the display 72 through the display lens 73.

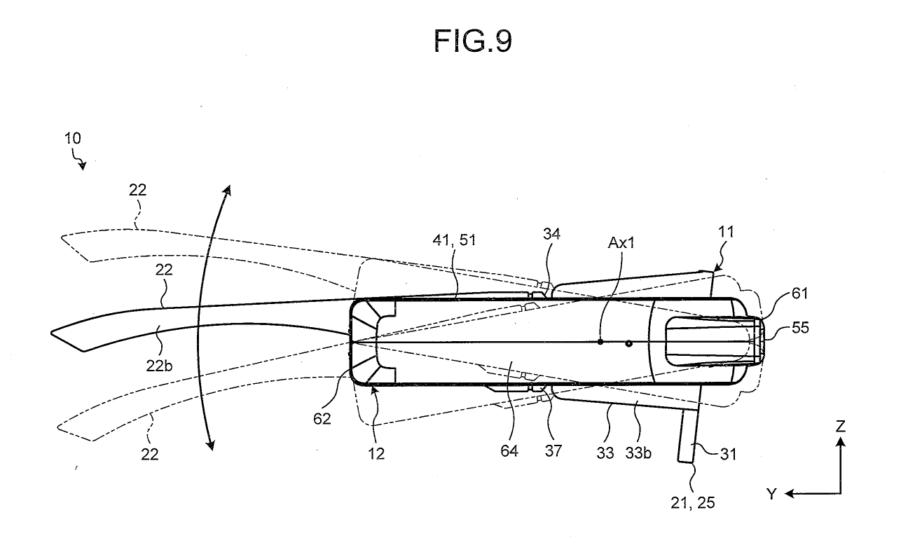

FIG. 9 is an exemplary side view of the HMD 10 with the temple 22 pivoted about the first rotational axis Ax1 according to the embodiment. As illustrated in FIG. 9, the user can turn the temple 22 about the first rotational axis Ax1. In FIG. 9 the turned temple 22 is represented by the chain double-dashed line.

Along with the turning of the temple 22 about the first rotational axis Ax1, the optical element 42 of the display device 12 attached to the temple 22 is also pivoted about the first rotational axis Ax1. Thus, the position of the optical element 42 with respect to the lens 26 is changed.

The user can turn the temple 22 about the first rotational axis Ax1 to move the optical element 42 with respect to the lens 26. The user can move the display lens 73 to the front of his or her eye to view the image on the screen 72a of the display 72 through the display lens 73.

In the HMD 10 according to the embodiment, the flexible arm 43 connects the body 41 and the optical element 42 with each other mutually movably and holds the optical element 42 with respect to the body 41. With this configuration, the position of the optical element 42 can be easily adjusted.

Furthermore, the vertical stopper 95 provided on one of the body 41 and the optical element 42 contacts the other of the body 41 and the optical element 42 while moved in the Z-axis direction, to limit the movement of the other of the body 41 and the optical element 42 along the Z-axis. With this configuration, the flexible arm 43 and the FPC 75 that connect the body 41 and the optical element 42 are prevented from being damaged by an increased movement of the optical element 42 with respect to the body 41.

A cable that connects the substrate 52 and the display 72 with each other can be inserted through the inside of the flexible arm 43, for example. However, the flexible arm 43 of the present embodiment connects the body 41 and the optical element 42 with each other at the distant position from the FPC 75. In other words, the flexible arm 43 is separated from the FPC 75. Thereby, the flexible arm 43 that holds the optical element 42 with respect to the body 41 can be downsized, as a result, prevented from obstructing the user's view.

The length of the first exposed portion 91 is shorter than the length of the second exposed portion 92. Thereby, the FPC 75 that electrically connects the substrate 52 and the display 72 is prevented from being damaged. Furthermore, the flexible arm 43 is relatively long, which helps the optical element 42 connected to the body 41 via the flexible arm 43 move more easily.

With use of a cable in place of the FPC 75, for example, a connector for converting signals that are transmitted through the cable may be provided. However, in the present embodiment, the FPC 75 is connected to the display 72. Because of this, the connector is unneeded, whereby the optical element 42 can be downsized. Consequently, the optical element 42 can be prevented from obstructing by the user's view.

Furthermore, in the HMD 10 of the present embodiment, the vertical stopper 95 limits the movement of the body 41 or the optical element 42 along the Z-axis. This can prevent the FPC 75 from being twisted due to an increased movement of the optical element 42 with respect to the body 41.

The FPC 75 is partially housed in the body 41 and inserted through the slit 87 in the body 41. With this configuration, the FPC 75 that electrically connects the substrate 52 and the display 72 with each other is prevented from being damaged. Furthermore, the slit 87 extends in the Z-axis direction, whereby when the optical element 42 moves in the Z-axis direction with respect to the body 41, the movement of the FPC 75 is not limited.

The part of the optical element 42 is placed in-between the first protrusion 95b and the second protrusion 95c of the vertical stopper 95. This enables downsizing of the optical element 42 from the size thereof when provided with the first and second protrusions 95b and 95c, for example. Thereby the optical element 42 can be prevented from obstructing the user's view.

The junction 85 connected to the flexible arm 43 is positioned in-between the first protrusion 95b and the second protrusion 95c. This can shorten the distance between the first protrusion 95b and the second protrusion 95c from that when the second casing 71 of the optical element 42 is positioned in-between the first protrusion 95b and the second protrusion 95c, for example. Thereby, the first and second protrusions 95b and 95c can be prevented from obstructing the user's view. Furthermore, the second casing 71 of the optical element 42 is prevented from being damaged by the first or second protrusion 95b or 95c.

The vertical stopper 95 limits the movement of the body 41 or the optical element 42 along the Z-axis and along the surface 26a of the lens 26. With this configuration, when the user adjusts the position of the optical element 42 to his or her eye, for example, the flexible arm 43 and the FPC 75 are prevented from being damaged by the increased movement of the optical element 42 with respect to the body 41.

The FPC 75 is farther from the front member 21 than the flexible arm 43. Accordingly, the FPC 75 is prevented from being damaged by the front member 21.

The lateral stopper 68 on the body 41 contacts the outer face 36a of the first pivot portion 36 of the front member 21 facing the circumference of the second rotational axis Ax2. With this configuration, even when the temple 22 is pivoted about the second rotational axis Ax2, the body 41 mounted on the temple 22 is prevented from pivoting about the second rotational axis Ax2. Consequently, unintentional movement of the optical element 42 due to the pivoting of the temple 22 can be prevented.

The flexible arm 43 is connected to the body 41 at the position closer to the lateral stopper 68 than the bosses 67. The lateral stopper 68 contacts the front member 21, so that it unlikely moves with respect to the front member 21 when the temple 22 is pivoted about the second rotational axis Ax2. Therefore, when the temple 22 is pivoted about the second rotational axis Ax2, the flexible arm 43 and the optical element 42 connected to the flexible arm 43 are prevented from being moved.

The contact stopper 98 is provided on the optical element 42, protruding toward the lens 26. With this configuration, when the optical element 42 approaches the lens 26, the contact stopper 98 contacts the lens 26 to prevent the contact between the display lens 73 and the lens 26. Consequently, the lens 26 and the display lens 73 are prevented from being damaged.

The temple 22 is pivotable relative to the front member 21 about the first rotational axis Ax1 that crosses the second rotational axis Ax2. Accordingly, the body 41 attached to the temple 22 and the optical element 42 connected to the body 41 are also pivotable about the first rotational axis Ax1. Consequently, by pivoting the temple 22 about the first rotational axis Ax1, the position of the display lens 73 of the optical element 42 can be changed.

In the above description, the display device 12 is attached to the eyeglasses 11. However, the display device 12 may also be attached to other ornaments such as goggles, a helmet, a cap or a hat, a hair band, and a sun visor, for example.

According to at least one embodiment described above, the first limiter contacts the first unit or the second unit when moved in the first direction to thereby limit the movement of the first unit or the second unit in the first direction. With this configuration, the flexible first and second connectors that connect the first unit and the second unit with each other are prevented from being damaged by the increased movement of the second unit with respect to the first unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first unit including a substrate;
a second unit separated from the first unit, including a display configured to display an image, an emitter configured to be exposed externally, and an optical guide configured to emit light of the image displayed on the display from the emitter;
a flexible first connector configured to electrically connect the substrate and the display with each other;
a flexible second connector configured to connect the first unit and the second unit with each other in a mutually movable manner and hold the second unit with respect to the first unit; and
a first limiter provided in one of the first unit and the second unit, the first limiter configured to contact the other of the first unit and the second unit when moved in a first direction to limit movement of the other of the first unit and the second unit in the first direction.

2. The display device according to claim 1, wherein the second connector connects the first unit and the second unit with each other at a position separate from the first connector.

3. The display device according to claim 2, wherein
the first connector includes a first exposed portion extending between the first unit and the second unit and exposed externally,
the second connector includes a second exposed portion extending between the first unit and the second unit and exposed externally, and
a length of the first exposed portion is shorter than a length of the second exposed portion.

4. The display device according to claim 1, wherein the first connector includes a flexible substrate configured to be connected to the display.

5. The display device according to claim 4, wherein
the first unit is provided with an opening extending in the first direction,
a part of the flexible substrate is housed in the first unit, and
the flexible substrate is inserted through the opening.

6. The display device according to claim 1, wherein
the first limiter includes a basal plane provided in the first unit, a first protrusion that protrudes from the basal plane, and a second protrusion separates from the first protrusion in the first direction, protruding from the basal plane, and
a part of the second unit is configured to be positioned in-between the first protrusion and the second protrusion.

7. The display device according to claim 6, wherein
the second unit includes a junction connected to the second connector, and
the junction is configured to be positioned in-between the first protrusion and the second protrusion.

8. A head mounted display comprising:
a cover including a lens;
a temple connected to the cover and pivotable about a first axis with respect to the cover;
a first unit including a substrate and configured to be attached to the temple;
a second unit separated from the first unit, including a display configured to display an image, an emitter configured to face the lens, and an optical guide configured to emit light of the image displayed on the display from the emitter;
a flexible first connector that electrically connects the substrate and the display with each other;
a flexible second connector configured to connect the first unit and the second unit with each other in a mutually movable manner and hold the second unit with respect to the first unit; and
a first limiter provided in one of the first unit and the second unit, the first limiter configured to contact the other of the first unit and the second unit moved in a first direction to limit movement of the other of the first unit and the second unit in the first direction.

9. The head mounted display according to claim 8, wherein
the lens has a surface configured to oppose the emitter, and
the first limiter is configured to limit movement of the first unit or the second unit in the first direction along the surface of the lens.

10. The head mounted display according to claim 8, wherein the second connector connects the first unit and the second unit with each other at a position separate from the first connector.

11. The head mounted display according to claim 10, wherein
the first connector includes a first exposed portion extending between the first unit and the second unit and exposed externally,
the second connector includes a second exposed portion extending between the first unit and the second unit and exposed externally, and
a length of the first exposed portion is shorter than a length of the second exposed portion.

12. The head mounted display according to claim 10, wherein the first connector is farther from the cover than the second connector.

13. The head mounted display according to claim 8, wherein the first connector includes a flexible substrate configured to be connected to the display.

14. The head mounted display according to claim 13, wherein
the first unit is provided with an opening extending in the first direction,
a part of the flexible substrate is housed in the first unit, and
the flexible substrate is inserted through the opening.

15. The head mounted display according to claim 8, wherein
the first limiter includes a basal plane provided in the first unit, a first protrusion that protrudes from the basal plane, and a second protrusion separated from the first protrusion in the first direction, protruding from the basal plane, and
a part of the second unit is configured to be positioned in-between the first protrusion and the second protrusion.

16. The head mounted display according to claim 15, wherein
the second unit includes a junction connected to the second connector, and
the junction is configured to be positioned in-between the first protrusion and the second protrusion.

17. The head mounted display according to claim 8, further comprising a second limiter provided in the first unit, wherein
the cover includes a side face directed to a circumferential direction of the first axis, and
the second limiter contacts the side face of the cover.

18. The head mounted display according to claim 17, wherein
the first unit includes an affixing portion configured to be attached to the temple, and
the second connector is connected to the first unit at a position closer to the second limiter than the affixing portion.

19. The head mounted display according to claim 8, further comprising a third limiter provided in the second unit, protruding toward the lens.

20. The head mounted display according to claim 8, wherein the temple is pivotable about a second axis that crosses the first axis with respect to the cover.
